(19) United States
(12) Patent Application Publication
(10) Pub. No.: US 2024/0193370 A1
(43) Pub. Date: Jun. 13, 2024

(54) INFORMATION PROCESSING APPARATUS, INFORMATION PROCESSING SYSTEM, INFORMATION PROCESSING METHOD, AND STORAGE MEDIUM

(71) Applicant: CANON KABUSHIKI KAISHA, Tokyo (JP)

(72) Inventor: KEN ACHIWA, Kanagawa (JP)

(21) Appl. No.: 18/533,685

(22) Filed: Dec. 8, 2023

(30) Foreign Application Priority Data
Dec. 13, 2022 (JP) 2022-198609

(51) Int. Cl. G06F 40/295; G06V 30/10

(52) U.S. Cl. CPC G06F 40/295; G06V 30/10

(57) ABSTRACT

To make it possible to extract a character string corresponding to each extraction-target item with accuracy even in a case where the character string ranges of a plurality of extraction-target items overlap one another in the task of named entity recognition. By using a training model trained to extract a character string corresponding to each of a plurality of items within a document, a character string corresponding to each of the plurality of items is extracted and output for an input document image. Then, a character string corresponding to an item among the plurality of items, for which a corresponding character string is not extracted, is re-extracted from the character string output by the first extracting.

### BACKGROUND

### Field

The present disclosure relates to a technique to extract character information from a document image.

### Description of the Related Art

Conventionally, there is a technique to extract a character string of an item value corresponding to a predetermined item, such as title, date, and amount, from a scanned image of a document (for example, a bill, and generally called “semi-typical business form”) created in a layout different for each company or each type. This technique is generally implemented by OCR (Optical Character Recognition) and NER (Named Entity Recognition). That is, this technique is implemented by, first, obtaining a character string group described within a document by performing OCR processing for the scanned image of the document (in the following, called “document image”), and then, inputting the character string group to a training model, and based on a feature amount represented by an embedded vector of the character string group, classifying the character string corresponding to the item value of the extraction-target item into a predetermined label and outputting the character string. Then, Japanese Patent Laid-Open No. 2022-79439 has disclosed a technique (single label classification) to classify each character string included in a document image into one of item labels in the task of named entity recognition. According to the technique of Japanese Patent Laid-Open No. 2022-79439, for example, it is possible to classify a character string of “Oct. 7, 2017” into a single label of “Date”. Further, Japanese Patent Laid-Open No. 2022-33493 has disclosed a technique (multilabel classification) to tag a character string configuring a single document to a plurality of document type labels in the task of document type determination. According to the technique of Japanese Patent Laid-Open No. 2022-33493, for example, it is possible to classify a single news article such as “the stock price drops due to the corona virus” into a plurality of related labels, such as “Medical Service”, “Stock Price/Exchange”, and “Infectious Disease”.

There is a case where in part of a character string corresponding to a certain item within a document, a character string corresponding to another item is included. For example, in a case of a bill, such a case is where a company name and date are included in part of a title, such as “XXX Inc. Invoice” or “Invoice (As of 04/01/2022). This means that character string ranges of a plurality of extraction-target items overlap one another in the task of named entity recognition. In the case such as this, in the above-described example of “XXX Inc. Invoice”, it is necessary to classify the character string “XXX Inc.” into the label of “Company Name” and the character string “XXX Inc. Invoice” into the label of “Title”. This can be implemented by applying the above-described technique of the multilabel classification to the task of named entity recognition, but in that case, there is such a problem that in order to deal with N items, the processing cost becomes N times and further, the increase in the number of labels reduces the extraction accuracy.

### SUMMARY

The information processing apparatus according to the present disclosure is an information processing apparatus including: one or more memories storing instructions; and one or more processors executing the instructions to perform: first extracting to extract, by using a training model trained to extract a character string corresponding to each of a plurality of items within a document, a character string corresponding to each of the plurality of items for an input document image; and second extracting to extract a character string corresponding to an item among the plurality of items, for which a corresponding character string is not extracted by the first extracting, from the character string obtained by the first extracting.

Further features of the present disclosure will become apparent from the following description of exemplary embodiments with reference to the attached drawings.

### BRIEF DESCRIPTION OF THE DRAWINGS

FIG. 1 is a diagram showing a configuration example of an information processing system;

FIG. 2A to FIG. 2C are conceptual diagrams showing the operation of a character string extractor;

FIG. 3A to FIG. 3C are diagrams showing a hardware configuration example of a user terminal, a training device, and an image processing server, respectively, configuring the information processing system;

FIG. 4 is a sequence diagram showing a flow of whole processing in the information processing system;

FIG. 5A and FIG. 5B are each a diagram showing one example of a UI screen for designating an extraction-target character string;

FIG. 6 is a diagram showing one example of a UI screen for a user to check extraction results;

FIG. 7 is a flowchart showing details of processing to generate a training model according to a first embodiment;

FIG. 8A and FIG. 8B are each a diagram explaining a process to output a named entity label by using BERT;

FIG. 9 is a flowchart showing details of processing to extract a candidate character string corresponding to a predetermined item from a document image according to the first embodiment;

FIG. 10A to FIG. 10C are diagrams explaining the behavior of a classifier;

FIG. 11 is a flowchart showing details of processing to generate a training model according to a second embodiment; and

FIG. 12 is a flowchart showing details of processing to extract a candidate character string corresponding to a predetermined item from a document image according to the second embodiment.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

### <System Configuration>

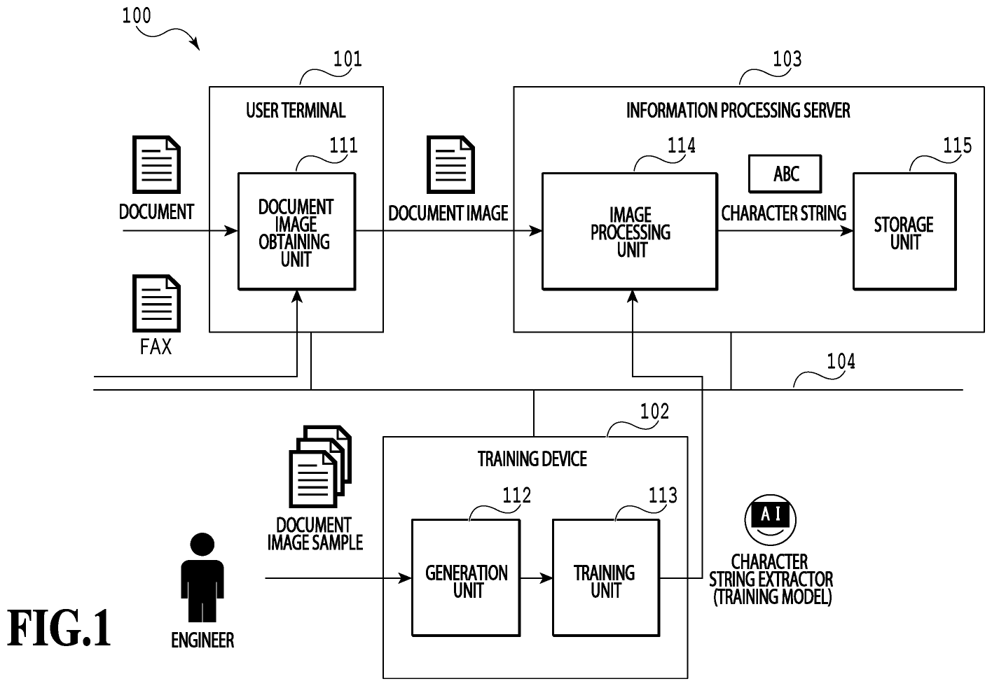

FIG. 1 is a diagram showing a configuration example of an information processing system according to the present embodiment. As shown in FIG. 1, an information processing system 100 includes, for example, a user terminal 101, a training device 102, and an information processing server 103 and each device is connected to one another via a network 104 implemented by LAN, WAN or the like. In the information processing system 100, each of the user terminal 101, the training device 102, and the information processing server 103 may have a configuration in which a plurality of devices is connected to the network 104, in place of a single device being connected to the network 104. For example, the information processing server 103 may include a first server device having a fast computing resource and a second server device having a large-capacity storage and may have a configuration in which both the server devices are connected to each other via the network 104.

The user terminal 101 is implemented by an MFP (Multi-Function Peripheral) comprising a plurality of functions, such as the print function, the scan function, and the FAX function. The user terminal 101 has a document image obtaining unit 111 and generates a document image by optically reading a document (printed material of semi-typical business form, such as a bill) and transmits the document image to the information processing server 103. Further, the document image obtaining unit 111 generates a document image by receiving FAX data transmitted from a facsimile transmitter, not shown schematically, and performing predetermined FAX image processing, and transmits the generated document image to the information processing server 103. The user terminal 101 is not limited to the MFP comprising the scan function and the FAX reception function and for example, may have a configuration that is implemented by a PC (Personal Computer) or the like. Specifically, it may also be possible to transmit a document file, such as PDF and JPEG, which is generated by using a document creation application running on the PC, to the information processing server 103 as a document image.

The training device 102 has a generation unit 112 and a training unit 113. The generation unit 112 generates, based on samples of a plurality of document images provided by an engineer, document data as training data, in which a Ground Truth label is assigned to an extraction-target character string of a character string group included in each sample. The training unit 113 obtains a training model (learning model) functioning as a character string extractor configured to estimate an extraction-target character string included in the document data by performing training by using the training data generated by the generation unit 112.

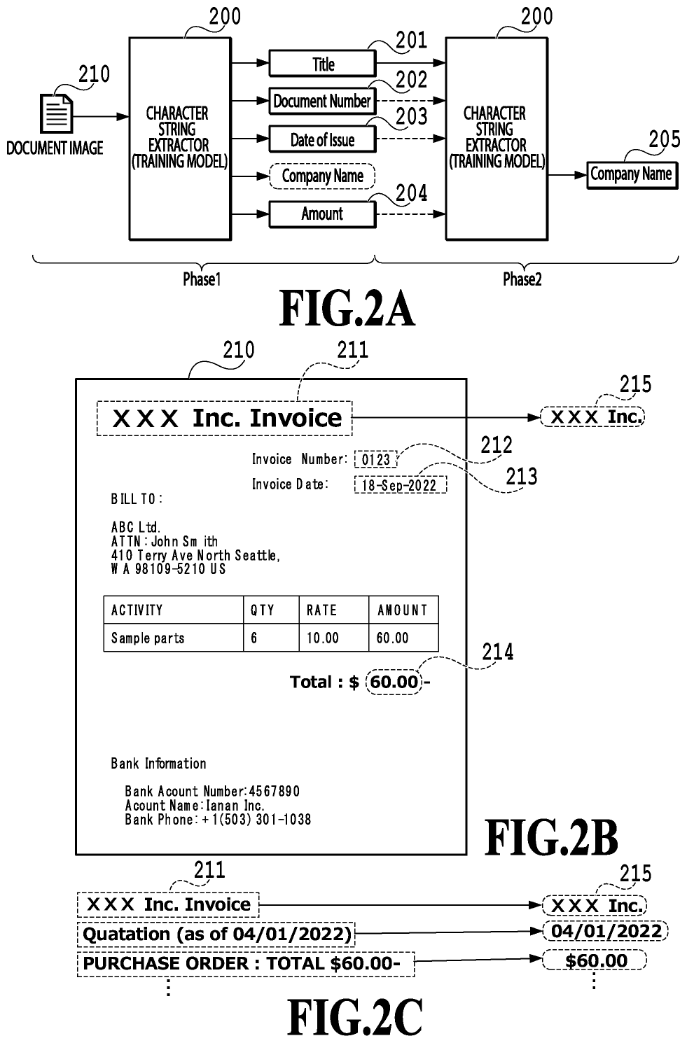

The information processing server 103 has an image processing unit 114 and a storage unit 115 and extracts a character string corresponding to an item set in advance from the document image received from the user terminal 101 and classifies the character string. First, the image processing unit 114 of the information processing server 103 performs OCR processing for the input document image and obtains recognized character string data as OCR results. Further, the image processing unit 114 extracts a character string corresponding to an item set in advance from the obtained recognized character string data by utilizing the training model (character string extractor) provided from the training device 102 and classifies the character string into a predetermined item label. Here, the extraction-target character string is generally called named entity and the proper noun, such as person name and place name, the date, the amount and the like correspond to the named entity, which have a variety of representations for each country and language. In the following explanation, the item label indicating the classification results of an extraction-target item having a named entity (for example, company name, date of issue, total amount, title) is called “named entity label”. FIG. 2A to FIG. 2C are conceptual diagrams showing the way the above-described character string extractor classifies and extracts a character string corresponding to an extraction-target item from an input document image. As shown in FIG. 2A, in Phase 1, a character string extractor 200 extracts and outputs character strings corresponding to a plurality of extraction-target items, such as “Title” 201, “Document Number” 202, “Date of Issue” 203, and “Amount” 204, by taking a document image 210 as an input. Further, in Phase 2, the character string extractor 200 extracts and outputs a character string corresponding to an extraction-target item, which cannot be extracted in Phase 1, by taking the character strings extracted in Phase 1 as an input. FIG. 2B is a specific example of the document image 210 in FIG. 2A. In Phase 1 and Phase 2, respectively, as in the following, character strings 211 to 215 corresponding to the extraction-target items 201 to 204 and an extraction-target item 205, respectively, are extracted and stored in the storage unit 115.

<<Phase 1>>
• “Title”: “XXX Inc. Invoice
• “Document Number”: “0123”
• “Date of Issue”: “18-Sep-2022”
• “Amount”: “60.00”
<<Phase 2>>
• “Company Name”: “XXX Inc.”

### <Hardware Configuration>

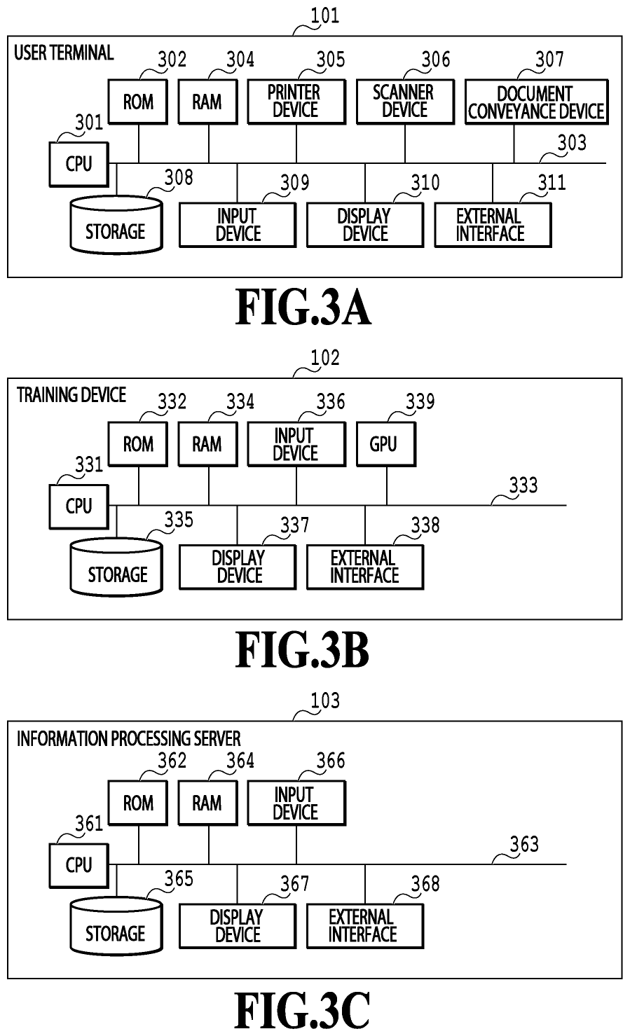

FIG. 3A to FIG. 3C are diagrams showing a hardware configuration example of the user terminal 101, the training device 102, and the image processing server 103, respectively, configuring the information processing system 100. In the following, each device is explained.

### <<Hardware Configuration of User Terminal>>

FIG. 3A is a diagram showing a hardware configuration example of the user terminal 101. As shown in FIG. 3A, the user terminal 101 includes a CPU 301, a ROM 302, a RAM 304, a printer device 305, a scanner device 306, a storage 308, an external interface 311 and the like and each device is connected to one another via a data bus 303.

The CPU 301 controls the whole operation in the user terminal 101. The CPU 301 boots the system of the user terminal 101 by executing the boot program stored in the ROM 302 and implements the functions, such as the print function, the scan function, and the FAX function of the user terminal 101, by executing control programs stored in the storage 308. The ROM 302 is a nonvolatile memory and stores the boot program to boot the user terminal 101. Via the data bus 303, transmission and reception of data are performed between the devices configuring the user terminal 101. The RAM 304 is a volatile memory and functions as a work memory in a case where the CPU 301 executes control programs. The printer device 305 is an image output device and performs print processing to print a document image, such as a bill, on a sheet and outputs the sheet. The scanner device 306 is an image input device and obtains a document image by optically reading a document, such as a bill. A document conveyance device 307 is implemented by an ADF (Auto Document Feeder) or the like and detects a document placed on a document table and conveys the detected document to the scanner device 306 one by one. The storage 308 is a large-capacity storage device, such as an HDD (Hard Disk Drive), and stores control programs and document images. An input device 309 is a touch panel, a hard key or the like and receives various operation inputs by a user. A display device 310 is a liquid crystal display or the like whose display is controlled by the CPU 301 and displays a UI screen to a user and displays and outputs various types of information. The external interface 311 connects the user terminal 101 to the network 104 and receives FAX data from a FAX transmitter, not shown schematically, transmits document image data to the information processing server 103, and so on.

### <<Hardware Configuration of Training Device>>

FIG. 3B is a diagram showing the hardware configuration of the training device 102. As shown in FIG. 3B, the training device 102 includes a CPU 331, a ROM 332, a RAM 334, a storage 335, an input device 336, a display device 337, an external interface 338, and a GPU 339 and each device is connected to one another via a data bus 333.

The CPU 331 controls the whole operation in the training device 102. The CPU 331 boots the system of the training device 102 by executing the boot program stored in the ROM 332. Further, the CPU 331 implements a character string extractor for extracting a named entity from character string data obtained by OCR processing for a document image by executing the training program stored in the storage 308. The ROM 332 is a nonvolatile memory and stores the boot program to boot the training device 102. Via the data bus 333, transmission and reception of data are performed between the devices configuring the training device 102. The RAM 334 is a volatile memory and functions as a work memory in a case where the CPU 331 executes the training program. The storage 335 is a large-capacity storage device, such as an HDD (Hard Disk Drive), and stores control programs and various types of data, such as document image samples, and the like. The input device 336 is a mouse, a keyboard or the like and receives various operation inputs by an engineer. The display device 337 is a liquid crystal display or the like whose display is controlled by the CPU 331 and displays and outputs various types of information to an engineer via a UI screen. The external interface 338 connects the training device 102 to the network 104 and receives document image data from a PC, not shown schematically, or the like, transmits a training model as a character string extractor to the information processing server 103, and so on. The GPU 339 includes an image processing processor and for example, performs training by using a document image sample in accordance with a control command given from the CPU 331 and generates a training model operating as a character string extractor for named entity recognition.

### <<Hardware Configuration of Information Processing Server>>

FIG. 3C is a diagram showing the hardware configuration of the information processing server 103. As shown in FIG. 3C, the information processing server 103 includes a CPU 361, a ROM 362, a RAM 364, a storage 365, an input device 366, a display device 367, and an external interface 368 and each device is connected to one another via a data bus 363.

The CPU 361 controls the whole operation in the information processing server 103. The CPU 361 boots the system of the information processing server 103 by executing the boot program stored in the ROM 362. Further, the CPU 361 performs information processing, such as character recognition and named entity recognition, by executing information processing programs stored in the storage 365. The ROM 362 is a nonvolatile memory and stores the boot program to boot the information processing server 103. Via the data bus 363, transmission and reception of data are performed between the devices configuring the information processing server 103. The RAM 364 is a volatile memory and functions as a work memory in a case where the CPU 361 performs the information processing programs. The storage 365 is a large-capacity storage device, such as an HDD (Hard Disk Drive), and stores the information processing programs described previously, document image data, a training model as a character string extractor, character string data and the like. The input device 366 is a mouse, a keyboard or the like used by a user to give instructions to the information processing server 103. The display device 367 is a liquid crystal display or the like whose display is controlled by the CPU 361 and presents various types of information to a user by displaying various UI screens. The external interface 368 connects the information processing server 103 to the network 104 and receives the training model from the training device 102, receives document image data from the user terminal 101, and so on.

### <Flow of Processing of Whole System>

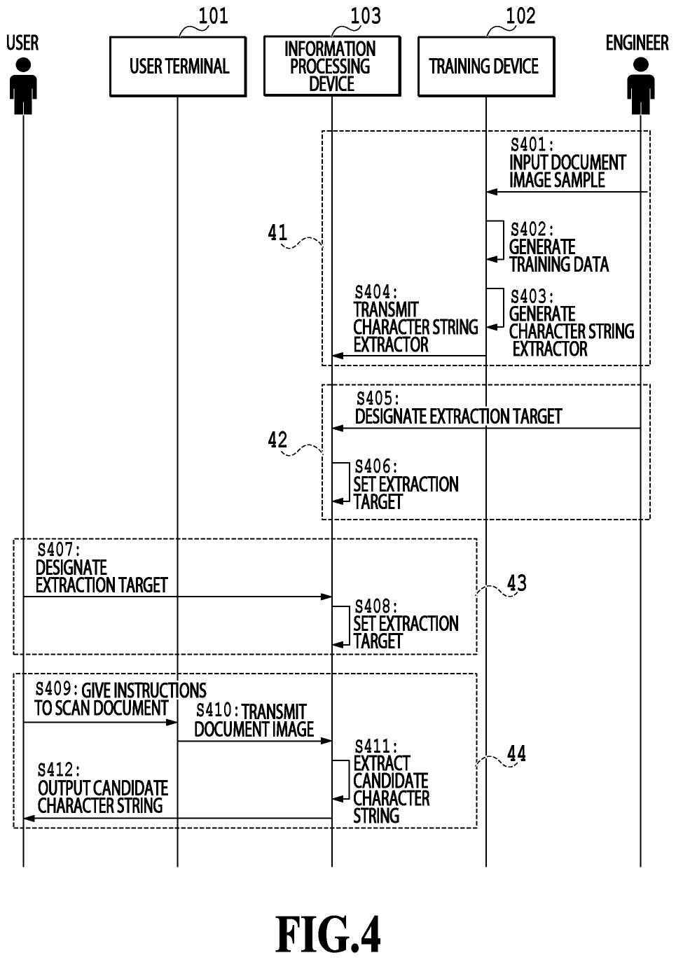

FIG. 4 is a sequence diagram showing a flow of the whole processing in the information processing system 100. In the sequence diagram in FIGS. 4, S401 to S404 indicated by a broken-line frame 41 indicate training in the training device 102 and output processing of training results (generation/transmission processing of character string extractor). Further, S405 and S406 indicated by a broken-line frame 42 indicate setting processing of an extraction-target character string by an engineer and S407 and S408 indicated by a broken-line frame 43 indicate setting processing of an extraction-target character string by a user. Then, S409 to S412 indicated by a broken-line frame 44 indicate named entity recognition processing in the information processing server 103. In the following, along the sequence diagram in FIG. 4, the flow of the whole processing in the information processing system 100 is explained.

### <<Generation/Transmission of Character String Extractor>>

First, an engineer inputs a plurality of document image samples to the training device 102 (S401). The training device 102 generates training data to which a named entity label corresponding to a character string scheduled to be set as an extraction target is attached as a Ground Truth label by performing character recognition (OCR) and named entity recognition (NER) by using the input document image samples (S402). Here, the Ground Truth label may be a label attached manually by an engineer or a label attached automatically by using a training model (character string extractor) by pretraining. Next, the training device 102 generates a training model as a character string extractor for capturing and extracting the feature of the extraction-target character string by performing training by using training data (S403). After that, the training device 102 transmits the generated character string extractor (training model) to the information processing server 103 (S404).

### <<Setting of Extraction-Target Character String by Engineer>>

This process is the action to set an extraction-target character string performed by an engineer at the time of development, and performed by an engineer at the time of development by predicting the setting contents supposed in the same setting action performed by a user at the time of application. The contents set in this process are presented to a user as default setting in the next process.

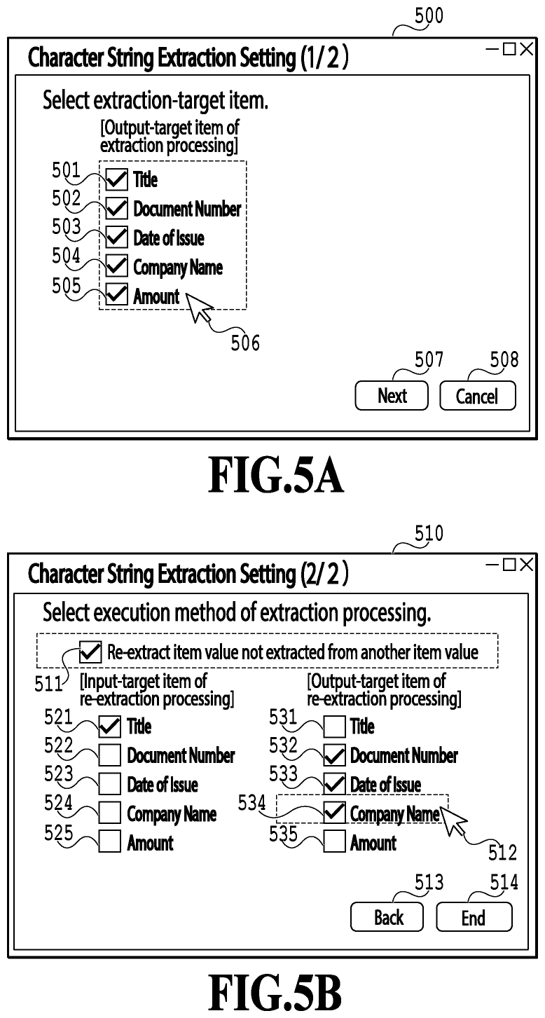

First, the information processing server 103 receives designation of an extraction-target character string from an engineer (S405). FIG. 5A and FIG. 5B are each a diagram showing one example of a UI screen (extraction setting screen) for designating an extraction-target character string, which is displayed on the display device 367. On an extraction setting screen 500 shown in FIG. 5A, checkboxes 501 to 505 corresponding to each item of “Title”, “Document Number”, “Date of Issue”, “Company Name”, and “Amount” exist. An engineer designates an extraction-target character string by checking the checkbox corresponding to an arbitrary item by operating a pointer 506. The engineer having completed the designation of an extraction-target character string presses down a “Next” button 507, which is a UI element within the extraction setting screen 500. Then, the screen makes a transition to an extraction setting screen 510 shown in FIG. 5B. A “Cancel” button 508 within the extraction setting screen 500 is a button that is pressed down in a case where the setting work is aborted on the way. On the extraction setting screen 510 shown in FIG. 5B, detailed settings relating to the extraction processing execution method are received. Specifically, it is possible for the engineer to designate the execution of re-extraction processing by operating a pointer 512 to check, for example, a checkbox 511. In a case of performing this designation, the engineer designates input-target items and output-target items of the re-extraction processing by checking checkboxes 521 to 525 and 531 to 535 corresponding to each item of “Title”, “Document Number”, “Date of Issue”, “Company Name”, and “Amount”. A “Back” button 513 within the extraction setting screen 510 is a button that is used in a case where it is desired to return to the extraction setting screen 500 shown in FIG. 5A. Further, an “End” button 514 is a button that the engineer presses down in a case of storing the set contents and ending the operation.

In a case where the “End” button 514 is pressed down, the information processing server 103 obtains the character string based on the received designation and sets a named entity label of the character string designated as the extraction target by using the character string extractor received from the training device 102 (S406).

### <<Setting of Extraction-Target Character String by User>>

This process is the action to set an extraction-target character string performed by a user at the time of application, and performed based on the default setting performed by a engineer described previously. Specifically, the information processing server 103 displays the extraction setting screen 500 or 510 on which the contents of the default setting are reflected on the display device 367 and receives the designation of an extraction-target character string from a user (S407). The designation method in this case may be the same as the designation method by an engineer, including the UI screens to be used. That is, in a case where there is no problem with the contents of the default setting as they are, it is possible for a user to press down the “End” button 514 on the extraction setting screen 510 immediately.

In a case where the designation by a user is completed, next, the information processing server 103 obtains the character string based on the received designation and sets a named entity label of the character string designated as the extraction target by using the character string extractor received from the training device 102 (S408).

<<Named Entity Recognition from Document Image>>

This process is a series of processing in which the information processing server 103 extracts and outputs a character string (in the following, described as “candidate character string”) that is taken to be a candidate of the extraction-target character string set by an engineer or a user him/herself from among the character strings included in the document image based on a request from a user. In the present embodiment, a candidate character string corresponding to a predetermined item is extracted repeatedly from, for example, a document image, such as a bill created in a layout different for each company, in accordance with conditions set via the extraction setting screens 500 and 510 shown in FIG. 5A and FIG. 5B described previously.

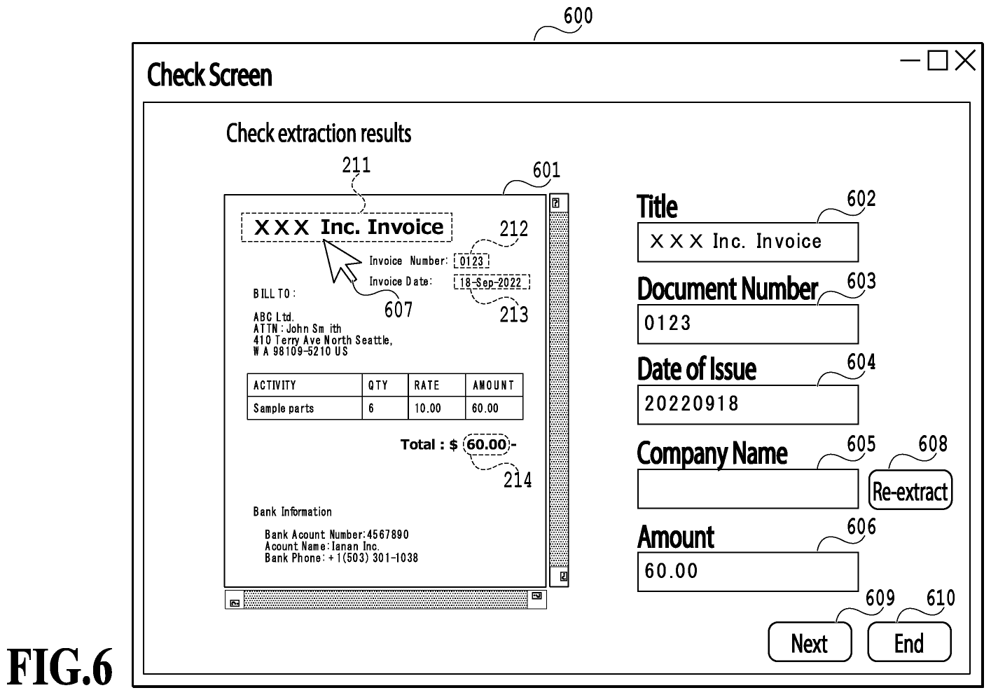

First, a user places a processing-target document (printed material of semi-typical business form and the like) on the user terminal 101 and gives instructions to perform a scan (S409). In response to this, the user terminal 101 transmits the document image obtained by the scan to the information processing server 103 (S410). Next, the information processing server 103 obtains the character string data included in the received document image by OCR processing and extracts a candidate character string from among the obtained character strings in accordance with the named entity label of the extraction-target character string set as described previously (S411). After that, the information processing server 103 outputs the extracted candidate character string to a user (S412). FIG. 6 is a diagram showing one example of a UI screen (check screen) displayed on the display device 367 for a user to check the extraction results. As shown on Check Screen 600 in FIG. 6, on the left side of the screen, a document image is displayed in a preview area 601. Further, on the right side of the screen, candidate character strings corresponding to each item of “Title”, “Document Number”, “Date of Issue”, “Company Name”, and “Amount”, respectively, are displayed in extraction results display areas 602 to 606 of each item. In a case where a candidate character string is displayed in the extraction results display area, it may also be possible to highlight the candidate character string corresponding to each item by changing the color of the candidate character string, and so on, on the preview-displayed document image. Further, it may also be possible to design a configuration in which it is possible for a user to give instructions to perform re-extraction processing on Check Screen 600 in FIG. 6 even in a case where the execution of the re-extraction processing is not designated in the setting work of the extraction-target character string described previously. In the UI screen example in FIG. 6, in the extraction results display area 605 of the item “Company Name”, nothing is displayed because a corresponding candidate character string is not extracted. In such a case, a user selects the re-extraction processing-target image area from within the preview-displayed document image by operating a pointer 607 with as a mouse or the like and presses down a “Re-extract” button 608, which is a UI element provided on Check Screen 600. In response to the user operation, it may also be possible for the information processing server 103 to perform the re-extraction processing and reflect the extraction results on Check Screen 600. A “Next” button 609 on Check Screen 600 is a button for causing the preview-display target to make a transition to a next document image and an “End” button 610 is a button for storing the extraction results and ending the processing.

### <Generation of Character String Extractor>

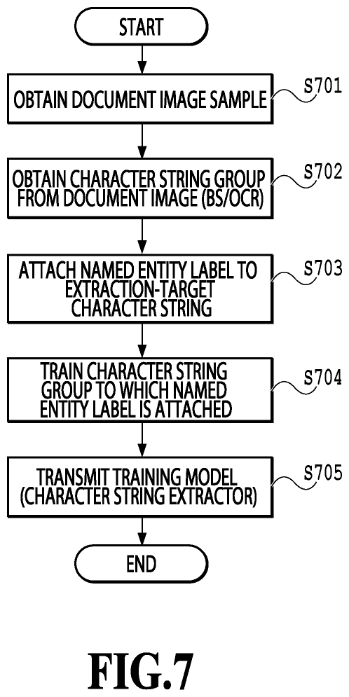

Following the above, the generation of a character string extractor (training model) in the training device 102 is explained. FIG. 7 is a flowchart showing details of the processing corresponding to the broken-line frame 41 (S401 to S404) in the sequence diagram in FIG. 4. The series of processing shown in FIG. 7 is implemented by the CPU 331 or the GPU 339 executing a program stored in one of the ROM 332, the RAM 334, and the storage 335 of the training device 102.

First, at S701, a plurality of document image samples is obtained. Specifically, a large number of document image samples, such as bills, estimate forms, and order forms created in a layout different for each issuing company, is input by an engineer.

At S702, for the document image samples obtained at S701, block selection (BS) processing to extract blocks for each object within the document image and character recognition (OCR) processing for character blocks are performed. Due to this, a character string group included in each sample of the document image is obtained. Here, it is sufficient to handle the character string group that is obtained for each character block obtained by the BS processing, that is, for each separated word arranged within the document image by being spaced or separated by a ruled line. Further, it may also be possible to handle the character string group that is obtained for each separated word into which divided by using the morphological analysis for the sentence included in the document image.

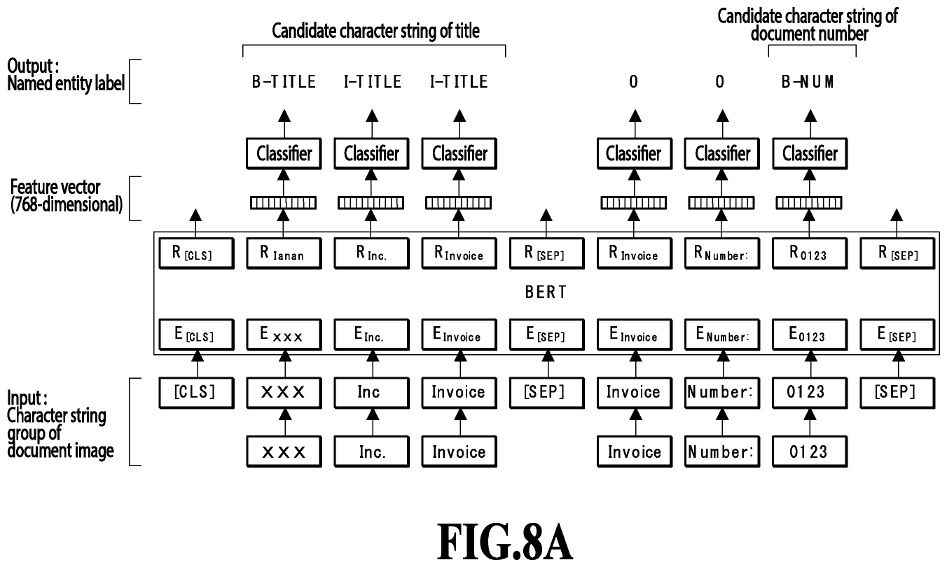

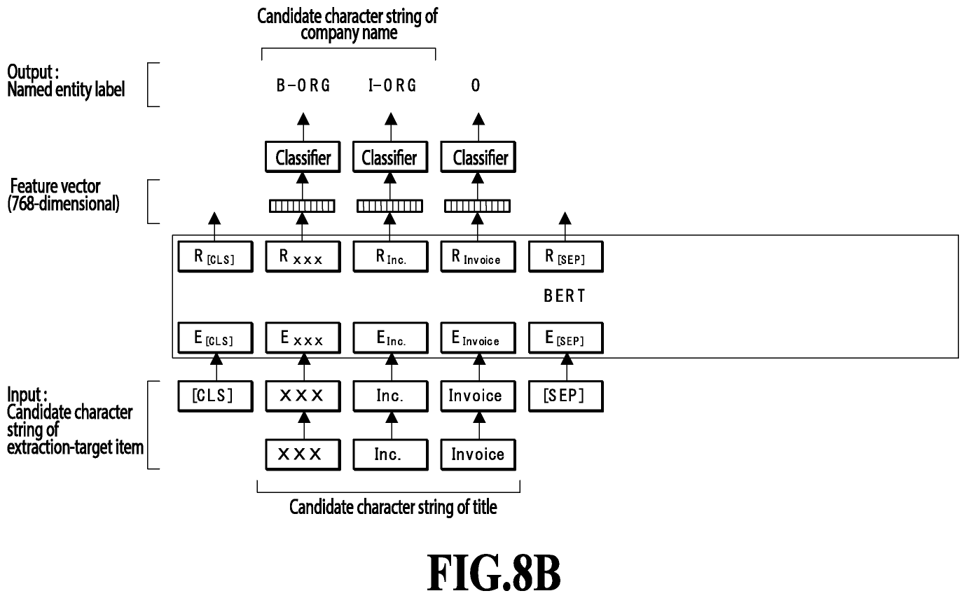

At S703, to the extraction-target character string included in the character string group obtained at S702, a named entity label (Ground Truth label) indicative of being an extraction-target item is attached. Then, at next S704, training using the character string group obtained at S702 and the named entity label attached at S703 is performed. Due to this, a training model (character string extractor) that captures and extracts the feature amount of the extraction-target character string is generated. Here, for the input to the training model, it may be possible to use the feature vector representing the feature amount of the character string converted by using the publicly known natural language processing technique, such as Word2Vec, fastText, BERT (Bidirectional Encoder Representations from Transformers), XLNet, and ALBERT, the position coordinates of the character string, and the like. For example, it is possible to convert single character string data into a feature vector represented by 768-dimensional numerical values by using a BERT language model having trained in advance a common sentence (for example, the whole article of Wikipedia). The training model is trained so as to be capable of outputting a named entity label determined in advance as estimation results for the input character string. Here, it may be possible for the training model to use logistic regression, decision tree, random forest, support vector machine, neural network or the like, which is commonly known as an algorithm of machine learning. For example, in accordance with the output value of the fully-connected layer of the neural network to which the feature vector output by the BERT language model, it is possible to output the estimation results of one of the named entity labels determined in advance. FIG. 8A and FIG. 8B are each a diagram explaining a process in which the input of a character string group included in a document image is converted into a 768-dimensional feature vector by using BERT and one of the named entity labels is output for each character string. FIG. 8A corresponds Phase 1 in FIG. 2A described previously and FIG. 8B corresponds to Phase 2 in FIG. 2A described previously. A character string group is input in the state where each so-called token is arranged in order in accordance with a predetermined reading order in a document image. This token is input as data together with commands, such as [CLS] at the top portion and [SEP] at the separation portion. By converting this input into a 768-dimensional feature vector (distributed representation) representing the feature amount of the character string by using BERT and by using a multiclass classifier taking the converted feature vector as an input, extraction of a candidate character string corresponding to each named entity label is implemented. In the example in FIG. 8A and FIG. 8B, an example is shown in which output results by the multiclass classifier are obtained in the BIO tag format generally used in the named entity recognition task. The multiclass classification method by this BIO tag format is a representation method making it possible to identify the gross range of a candidate character string corresponding to each named entity label by B (Begin), I (Inside), and O (Outside). Specifically, for example, the B-TITLE tag is utilized for the first character string of the item “Title”, the I-TITLE tag is utilized for the character string included within the character string range of the item “Title”, and the O tag is utilized for the character string that is not classified into any named entity label. By the training model thus obtained, from the character string included in the document image, it is possible to extract the candidate character string corresponding to the named entity label, that is, the character string range of I-TITLE following B-TITLE as the candidate character string of the item “Title”. FIG. 8B explains the way of Phase 2 in which re-extraction processing is further performed for the candidate character string extracted and output in Phase 1 shown in FIG. 8A. As shown in FIG. 8B, an attempt is made to extract the candidate character string that cannot be extracted in Phase 1 by inputting the candidate character string extracted by BERT to the BERT used in Phase 1 and limiting the named entity labels to part thereof. In the example in FIG. 8B, as the candidate character string of the item “Title”, the extracted candidate character string “XXX Inc. Invoice” is input. Then, the character string “XXX Inc.”, that is, the character string range of I-ORG that follows B-ORG is extracted as the candidate character string corresponding to the item “Company Name”. It is sufficient to control the named entity label used in the re-extraction processing such as this based on the setting via the extraction setting screen 510 shown in FIG. 5B described previously.

At S705, the training model as the character string extractor generated at S704 is transmitted to the information processing server 103 and the present processing is terminated.

The above is the contents of the processing to generate a training model as a character string extractor according to the present embodiment.

### <Extraction of Candidate Character String>

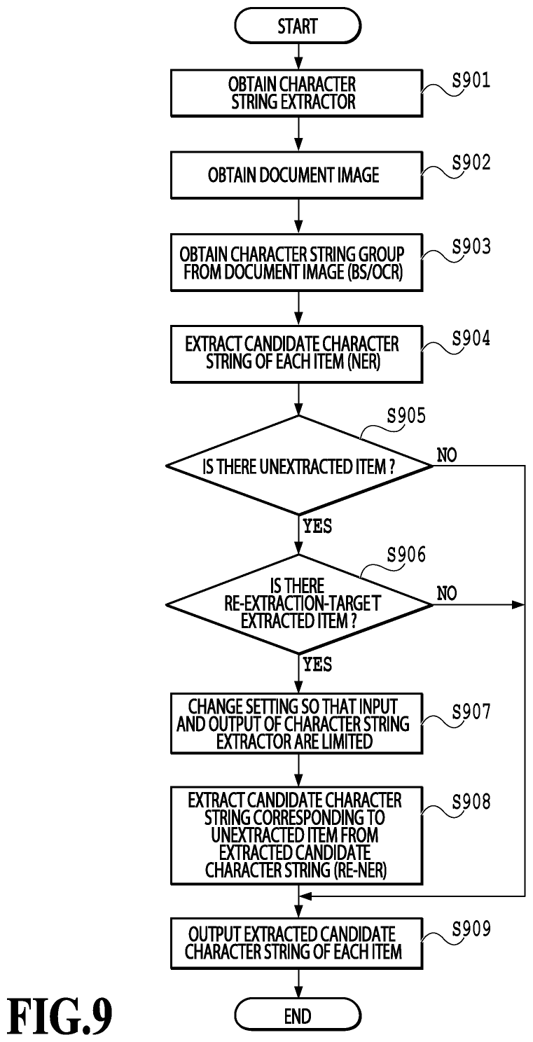

Next, processing to extract a candidate character string corresponding to a predetermined item from a document image in the information processing server 103 is explained. FIG. 9 is a flowchart showing details of the processing corresponding to the broken-line fame 44 (S407 to S412) in the sequence diagram in FIG. 4. The series of processing shown in FIG. 9 is implemented by the CPU 361 executing a program stored in one of the ROM 362, the RAM 364, and the storage 365.

First, at S901, the training model as the character string extractor, which is transmitted from the training device 102, is obtained (received). At next S902, the document image transmitted from the user terminal 101 is obtained (received).

At S903, for the input document image obtained at S902, BS processing and OCR processing are performed and a character string group configuring the input document image is obtained. At next S904, by using the character string extractor obtained at S901, from among the character string group obtained at S903, the candidate character string corresponding to the named entity label of the extraction-target item is extracted. The technique to recognize and extract a named entity is generally known as a classification task called NER (Named Entity Recognition) and can be implemented by an algorithm of machine learning using images and feature amounts of natural language.

At S905, based on the extraction results at S904, whether or not there is an unextracted item of the extraction-target items determined in advance is determined. In a case where the determination results indicate that there is an unexpected item, the processing makes a transition to S906 and in a case where there is no unextracted item, the processing makes a transition to S909.

At S906, based on the extraction results at S904, whether or not there is a re-extraction processing-target item among the extracted items of the extraction-target items determined in advance is determined. Here, it may also be possible to select all the extracted items as the re-extraction processing target, or it may also be possible to select only the specific items designated in advance by an engineer or a user as the re-extraction processing target. In a case where the determination results indicate that there is a re-extraction processing-target extracted item, the processing makes a transition to S907 and in a case where there is no re-extraction processing-target extracted item, the processing makes a transition to S909.

At S907, conditions are set for limiting the input and output of the character string extractor in accordance with the unextracted item determined at S905 and the specific extracted item selected at S906. That is, the setting is changed so that it is possible to output only the named entity label of the unextracted item as estimation results by adopting the output results of only the output node corresponding to the named entity label of the unextracted item among the plurality of output nodes of the fully-connected layer of the character string extractor. Further, control is performed so that only the re-extraction processing-target character string is input as the character string to be input to the character string extractor.

At S908, under the conditions of the input and output for the character string extractor, which are set at S907, by the NER processing using the same character string extractor as that at S904, the candidate character string of the unextracted item is extracted from the candidate character string of the extracted item.

Lastly, at S909, the candidate character string corresponding to each extraction-target item extracted at S904 and S908 is output. As a specific output aspect, for example, output processing is performed in which a file name and a folder name of a document image are automatically generated and presented to a user by using the candidate character string extracted from the document image at the time of the computerization of the document.

The above is the contents of the named entity recognition processing to obtain a candidate character string corresponding to a predetermined item from a document image according to the present embodiment.

### <Configuration of Classifier in Character String Extractor>

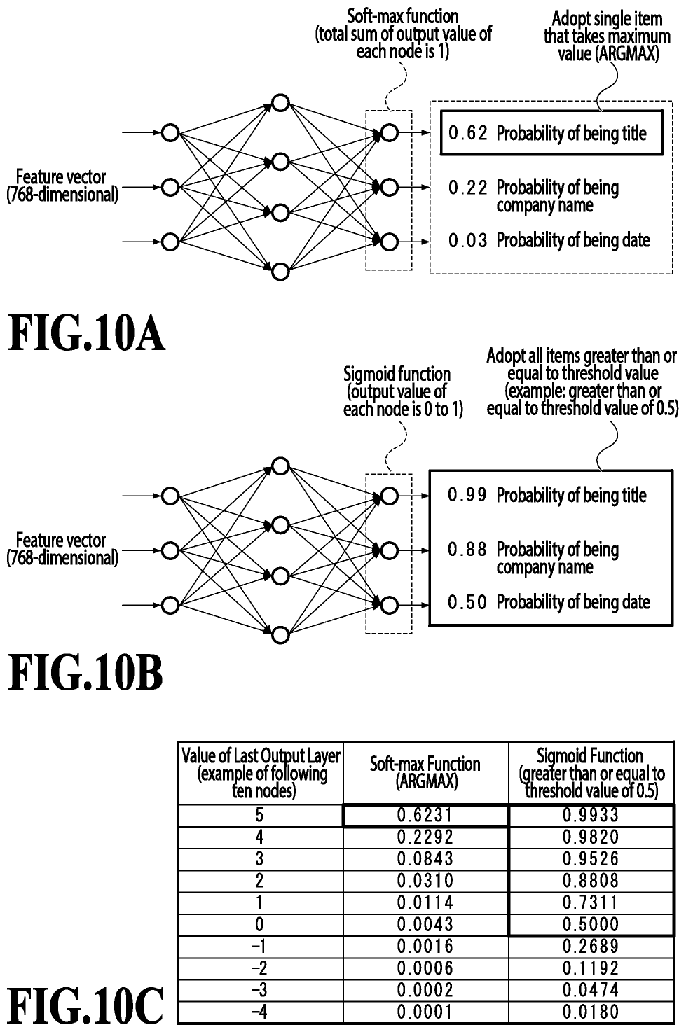

FIG. 10A to FIG. 10C are diagrams explaining the behavior of a classifier that classifies and outputs a named entity label from a feature vector input to a character string extractor. As shown in FIG. 10A, in a case where it is desired to obtain single label classification results, it is sufficient to use the soft-max function as the activation function of the output layer of the neural network (fully-connected layer) configuring the classifier. Due to this, it is possible to construct a training model in which the output value of each node has a value between “0 and 1” and generates a probability value so that the sum total of the output of each node is “1”. In FIG. 10A, by adopting one of the estimation results (ARGMAX), whose output value of each node is the maximum, it is possible to output the single label classification results by using the training model. Specifically, the estimation results are obtained, which indicate, for example, that the input character string is the character string belonging to “Title” of the named entity labels determined in advance. On the other hand, as shown in FIG. 10B, in a case where it is desired to obtain multilabel classification results, it is possible to construct a training model in which each output value of each node independently generates a probability value between “0 and 1” by using the sigmoid function as the activation function of the output of the fully-connected layer. By adopting all the estimation results whose output value of each node exceeds a predetermined threshold value (for example, 0.5) in FIG. 10B, it is possible to obtain the multilabel classification results by using the training model. For example, the estimation results are obtained, which indicate that the input character string is the character string belonging to each of “Title”, “Company Name”, and “Date” of the named entity labels determined in advance. Here, compared to the single label classification in FIG. 10A, the extraction accuracy of the multilabel classification in FIG. 10B is reduced because the number of possible combinations of classification results increases and the degree of difficulty of the named entity recognition task becomes high. Specifically, for example, in a case where the output values of the soft-max function and the sigmoid function are calculated for the value of the ten-node neural network (fully-connected layer) in which the value of the last output layer is different by “1” from the previous value and/or the next value, each value described in the table shown in FIG. 10C is obtained. Here, in a case of the single label classification, it is sufficient to adopt a single item that takes the maximum value, and therefore, in a case where the value of the last output layer is different by “1” from the previous value and/or the next value, it is possible to adopt the most probable item. On the other hand, in a case of the multilabel classification, depending on the design of the threshold value, a plurality of items is adopted, and therefore, in a case where the value of the last output layer is different by “1” from the previous value and/or the next value, many items more than necessary are extracted erroneously. As described above, in a case where the multilabel classification is used and the candidate character string ranges of a plurality of extraction-target items overlap one another, it is possible to design a mechanism of a training model, but it is difficult to perform extraction with a high accuracy. In contrast to this, in a case where the single label classification is used and the candidate character string ranges of a plurality of extraction-target items overlap one another as described in the present embodiment, it is made possible to perform extraction with a high accuracy by performing re-extraction processing in accordance with the results of the single label classification.

As above, according to the present embodiment, even in a case where the candidate character string ranges of a plurality of extraction-target items overlap one another, it is possible to extract each candidate character string corresponding to each extraction-target item. That is, in the example explained at the outset, it is possible to output the named entity label of the item “Company Name” for the character string of “XXX Inc.” and also output the named entity label of the item “Title” for the character string of “XXX Inc. Invoice”.

### Second Embodiment

The first embodiment is the aspect in which re-extraction processing is performed by using the same training model (character string extractor) whose input and output are limited. Next, an aspect is explained as a second embodiment, in which in re-extraction processing, a dedicated training model (second character string extractor) trained with a re-extraction-target character string is used. Explanation of the contents common to those of the first embodiment, such as the system configuration, is omitted and in the following, different points are explained.

### <Generation of Second Character String Extractor>

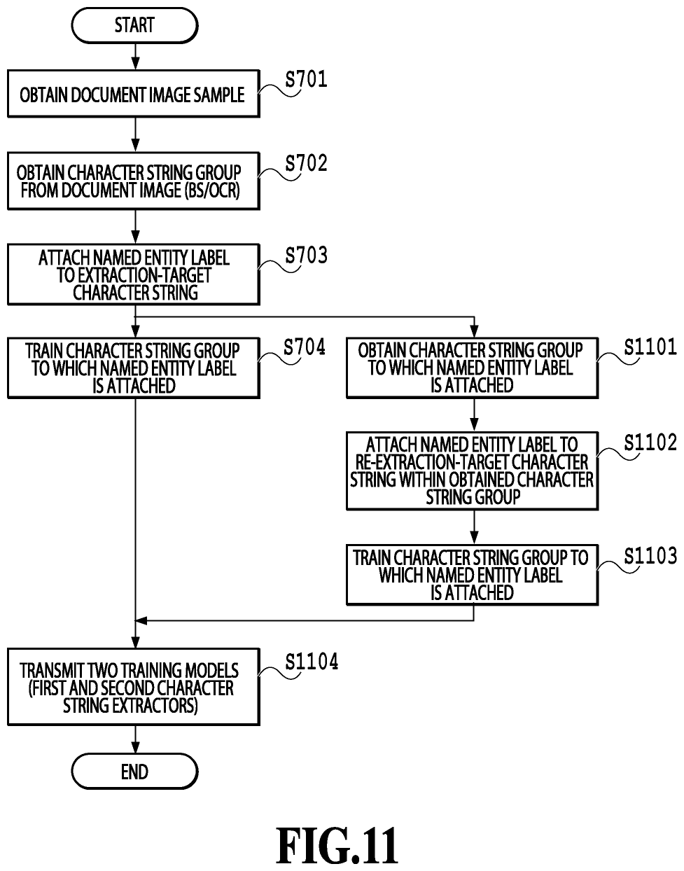

FIG. 11 is a flowchart explaining a flow of processing for the training device 10 to generate two character string extractors (training models) for the first extraction processing and the second extraction processing. The series of processing shown in the flowchart in FIG. 11 is also implemented by the CPU 331 or the GPU 339 executing a predetermined program as for the series of processing shown in the flowchart in FIG. 7, which is explained in the first embodiment. To the step whose contents are the same as those of the step in the flowchart in FIG. 7, the same reference symbol is attached and explanation thereof is omitted.

In the present embodiment, after the processing at S703 is completed, processing (S1101 to S1103) to generate a second character string extractor for re-extraction processing is performed in parallel to the processing (S704) to generate a first character string extractor for the first extraction processing. However, it is not necessarily required to perform parallel processing and it may also be possible to perform the processing in order.

At S1101, the character string group to which the named entity label is attached at S703 is obtained. At S1120 that follows, to the re-extraction-target character string included in the obtained character string group, the named entity label (Ground Truth label) indicative of being an extraction-target item is attached. For example, it is assumed that the character string “XXX Inc. Invoice” to which the named entity label of the item “Title” is attached is included in the character string group obtained at S703. In this case, to the partial character string “XXX Inc.” corresponding to part of the character string “XXX Inc. Invoice”, the named entity label of the item “Company Name” is attached newly at this step. The partial character string taken to be the target of re-extraction processing, to which the named entity label is attached at this step, is called “re-extraction-target character string” By this step, limitations are imposed so that a candidate character string to which a predetermined named entity label is attached is input to the character string extractor in place of the whole character string of each character block pulled out from a document image. Further, by this step, for example, the named entity labels that are output are also limited so that the candidate character strings corresponding to the items (for example, “Company Name”, “Date”, “Amount”) other than “Title” are extracted from the candidate character string corresponding to the item “Title”. In this manner, it is possible to deal with the problem that a training model should obtain in the task of named entity recognition by breaking down the problem into subsets for simplification.

At S1103, training using the character string group obtained at S1101 and the named entity label attached at S1102 is performed. Due to this, the training model as the second character string extractor for capturing an extracting the feature amount of the re-extraction-target character string is generated.

At S1104, the training model as the first character string extractor generated at S704 and the training model as the second character string extractor generated at S1103 are transmitted to the information processing server 103 and the present processing is terminated.

The above is the contents of the processing to generate two training models whose roles are different.

### <Extraction of Candidate Character String>

The flow of the candidate character string extraction processing is the same as that of the first embodiment and performed basically in accordance with the flowchart in FIG. 9 described previously. At that time, at S901, the two training models (the first character string extractor and the second character string extractor) transmitted from the training device 102 are obtained. Then, at S904, from the character string group obtained at S903 by using the first character string extractor, the candidate character string corresponding to the extraction-target named entity is extracted. Further, at S908, under the input and output conditions set at S907, from the candidate character string of the extracted item, the candidate character string of the unextracted item is extracted by using the second character string extractor.

As above, according to the present embodiment, by generating and using a dedicated training model specialized in re-extraction processing, it is possible to reduce the degree of difficulty of the classification task and improve the extraction accuracy.

### Third Embodiment

Next, an aspect is explained as a third embodiment, in which in re-extraction processing, no training model is used and key-value extraction based on a keyword and a data type of a predetermined candidate character string is performed. Explanation of the contents common to those of the first embodiment, such as the system configuration, is omitted.

### <Extraction of Candidate Character String>

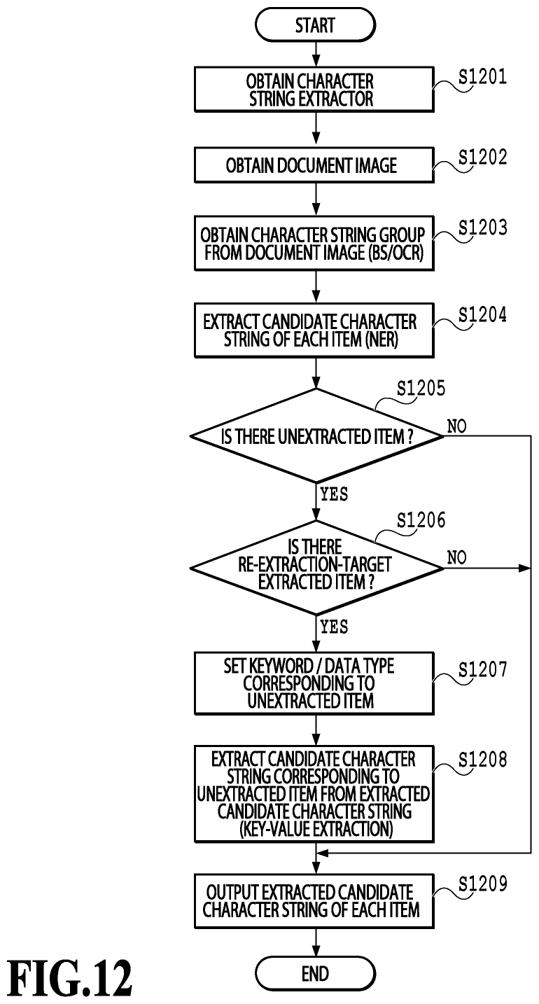

FIG. 12 is a flowchart showing details of the processing corresponding to the broken-line frame 44 (S407 to S412) in the sequence diagram in FIG. 4 according to the present embodiment. The series of processing shown in FIG. 12 is implemented by the CPU 361 executing a program stored in one of the ROM 362, the RAM 364, and the storage 365 of the information processing server 103. In the following, explanation of the same steps as those of the flowchart in FIG. 9 described previously according to the first embodiment is omitted and the re-extraction processing is explained mainly, which is the different point.

S1201 to S1206 are quite the same as S901 to S906 in the flowchart in FIG. 9. At S1207 in a case where it is determined that there is a re-extraction-target extracted item at S1206, the setting of a keyword and a data type determined in advance, which correspond to an unextracted item, is performed. Specifically, for example, in a case of the named entity label of the item “Company Name”, database of keywords of legal personality, such as “Inc.”, “Ltd.”, “Co.”, and “LLC”, and a list of the company names of clients is searched. Due to this, for example, it is made possible to newly extract “XXX Inc.” as the candidate character string corresponding to the item “Company Name” from the candidate character string “XXX Inc. Invoice” corresponding to the item “Title”. Further, for example, in a case of the named entity label of the item “Date”, the data type, such as “YYYY/MM/DD” and “YY-MM-DD”, and the keyword, such as “Jan”, “Feb”, and “Mar”, are searched for. Due to this, for example, it is made possible to newly extract “04/01/20” as the candidate character string corresponding to the item “Date” from the candidate character string “Quotation (as of 04/01/2022)” corresponding to the item “Title”. Further, for example, in a case of the named entity label of the item “Amount”, the keyword, such as “USD” and “$”, and numerals having one or more digits, which is represented in a regular expression, such as “¥ d {1,}”, adjacent to the keyword are searched for. Due to this, for example, it is made possible to newly extract “$60.00” as the candidate character string corresponding to the item “Amount” from the candidate character string “PURCHASE ORDER: TOTAL $60.00-” corresponding to the item “Title”.

At S1208, the extraction of the candidate character string corresponding to an unextracted item corresponding to a predetermined named entity label is performed. For this extraction, it is sufficient to use a publicly known rule-based technique generally called key-value extraction in accordance with the keyword and data type set at S1207.

At S1209, as at S909, the candidate character string corresponding to each extraction-target item extracted at S1204 and S1208 is output.

As above, according to the present embodiment, the rule-based key-value extraction processing is performed in place of performing again the estimation processing by a training model. Due to this, compared to the first embodiment and the second embodiment described previously, it is possible to reduce the processing cost in a case where the re-extraction processing is performed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, even in a case where the character string ranges of a plurality of extraction-target items overlap one another in the named entity recognition task, it is possible to extract the character string corresponding to each extraction-target item with a high accuracy.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-198609, filed Dec. 13, 2022 which is hereby incorporated by reference wherein in its entirety.

What is claimed is:

1. An information processing apparatus comprising:
one or more memories storing instructions; and
one or more processors executing the instructions to perform:
first extracting to extract, by using a training model trained to extract a character string corresponding to each of a plurality of items within a document, a character string corresponding to each of the plurality of items for an input document image; and
second extracting to extract a character string corresponding to an item among the plurality of items, for which a corresponding character string is not extracted by the first extracting, from the character string obtained by the first extracting.

2. The information processing apparatus according to claim 1, wherein
the second extracting is performed by using the training model used for the first extracting, whose input and output are limited.

3. The information processing apparatus according to claim 1, wherein
the second extracting is performed by using a training model different from the training model used for the first extracting, which is trained to extract a character string corresponding to a second item different from a first item from a character string corresponding to the first item of the plurality of items.

4. The information processing apparatus according to claim 1, wherein
in the second extracting, key-value extracting is performed, to which a keyword and a data type corresponding to an item among the plurality of items, for which a corresponding character string is not extracted by the first extracting, are set.

5. The information processing apparatus according to claim 1, wherein
the one or more processors further execute the instructions to perform setting an extraction-target item in the second extracting in advance and
the second extracting is performed in a case where the item among the plurality of items, for which a corresponding character string is not extracted by the first extracting, is the extraction-target item set in advance.

6. The information processing apparatus according to claim 1, wherein
the one or more processors further execute the instructions to perform causing a display unit to display a UI screen on which results of the first extracting are shown, on the UI screen, a UI element for a user to give instructions to perform the second extracting exists, and
based on user instructions via the UI screen, the second extracting is performed.

7. The information processing apparatus according to claim 6, wherein
the UI element is displayed on the UI screen in association with the item among the plurality of items, for which a corresponding character string is not extracted by the first extracting and
in the second extracting, a character string corresponding to the item with which the UI element is associated is extracted.

8. An information processing system comprising:
a training device generating a training model by performing training for extracting a character string corresponding to each of a plurality of items from a document image; and
an information processing apparatus performing first extracting to extract, by using the training model, a character string corresponding to each of the plurality of items for an input document image and second extracting to extract a character string corresponding to an item among the plurality of items, for which a corresponding character string is not extracted by the first extracting, from the character string obtained by the first extracting.

9. The information processing system according to claim 8, wherein
the second extracting is performed by using the training model used for the first extracting, whose input and output are limited.

10. The information processing system according to claim 8, wherein
the second extracting is performed by using a training model different from the training model used for the first extracting and
the training device further generates the other different training model by performing training for extracting a character string corresponding to a second item different from a first item from a character string corresponding to the first item of the plurality of items.

11. The information processing system according to claim 8, wherein
in the second extracting, key-value extracting is performed, to which a keyword and a data type corresponding to an item among the plurality of items, for which a corresponding character string is not extracted by the first extracting, are set.

12. An information processing method comprising the steps of:
performing first extracting to extract, by using a training model trained to extract a character string corresponding to each of a plurality of items within a document, a character string corresponding to each of the plurality of items for an input document image; and
performing second extracting to extract a character string corresponding to an item among the plurality of items, for which a corresponding character string is not extracted by the first extracting, from the character string obtained by the first extracting.

13. A non-transitory computer readable storage medium storing a program for causing a computer to perform an information processing method comprising the steps of:
performing first extracting to extract, by using a training model trained to extract a character string corresponding to each of a plurality of items within a document, a character string corresponding to each of the plurality of items for an input document image; and
performing second extracting to extract a character string corresponding to an item among the plurality of items, for which a corresponding character string is not extracted by the first extracting, from the character string obtained by the first extracting.
